(19) United States
(12) Patent Application Publication
(10) Pub. No.: US 2026/0011517 A1
(43) Pub. Date: Jan. 8, 2026

(54) CIRCUIT BREAKER

(71) Applicant: Schneider Electric Industries SAS, Rueil Malmaison (FR)

(72) Inventors: Yuchen YE, Shanghai (CN); Xuedong XIA, Shanghai (CN); Zhenyao GONG, Shanghai (CN)

(21) Appl. No.: 19/257,193

(22) Filed: Jul. 1, 2025

(30) Foreign Application Priority Data
Jul. 3, 2024 (CN) 202421569197.6

(51) Int. Cl. H01H 50/18; H01H 50/02; H01H 50/44; H01H 50/54

(52) U.S. Cl. CPC H01H 50/18; H01H 50/02; H01H 50/44; H01H 50/546

(57) ABSTRACT

A circuit breaker is provided and includes: a housing; an electromagnetic assembly disposed in the housing and including an electromagnetic coil and a movable core, wherein the movable core is adapted to move along a first direction when the electromagnetic coil is energized; a movable member disposed in the housing and connected to the movable core; a movable contact assembly disposed in the housing, interacting with the movable member and being adapted to move under driving of the movable member; a switch assembly disposed on the housing and including a microswitch; and a trigger disposed on one of the movable core, the movable member, and the movable contact assembly, wherein during movement of the movable core along the first direction when being pressed, the trigger moves under driving of the movable core and presses the microswitch, and the electromagnetic coil is energized when the microswitch is pressed.

### CROSS-REFERENCE

This application claims priority to Chinese Patent Application No. 202421569197.6, filed on Jul. 3, 2024, and entitled “CIRCUIT BREAKER”, the entirety of which is incorporated herein by reference.

### FIELD

Embodiments of the present disclosure generally relate to the technical field of electrical equipment, and more particularly, to a circuit breaker.

### BACKGROUND

A circuit breaker includes a mechanical switch and an electronic switch, and in a case that the mechanical switch and the electronic switch are connected in series, it should be ensured that the mechanical switch is closed prior to the electronic switch being closed during a closing process and the mechanical switch is opened after the electronic switch being opened during an opening process. The mechanical switch can be opened or closed by means of driving a movable contact assembly by manually pressing a button or remotely controlling an electromagnetic assembly.

During processes of manually closing and opening a conventional circuit breaker, it is necessary to press a movable contact assembly from a closed position/open position to a dead point position, and then the movable contact assembly rebounds to the open position/closed position. During a process of pressing the movable contact assembly to the dead point position, if an operator stops applying a force after the microswitch is pressed, the electronic switch may switch a state, but the movable contact assembly bounces back to the initial position, so that the breaker cannot realize the function of closing first and opening later.

### SUMMARY

In one aspect of the present disclosure, a circuit breaker is provided. The circuit breaker includes: a housing; an electromagnetic assembly disposed in the housing and including an electromagnetic coil and a movable core disposed in the electromagnetic coil, wherein the movable core is adapted to move along a first direction when the electromagnetic coil is energized; a movable member disposed in the housing and connected to the movable core; a movable contact assembly disposed in the housing, wherein the movable contact assembly interacts with the movable member and is adapted to move under driving of the movable member; a switch assembly disposed on the housing and including a microswitch; and a trigger disposed on one of the movable core, the movable member, and the movable contact assembly, wherein during movement of the movable core along the first direction when being pressed, the trigger moves under driving of the movable core and is adapted to press the microswitch, and the electromagnetic coil is energized when the microswitch is pressed.

In some embodiments, the movable contact assembly includes a movable contact bracket, the trigger is disposed on the movable contact bracket, and an end of the trigger passes through the housing.

In some embodiments, the switch assembly further includes a circuit board disposed on an outer surface of the housing, the circuit board includes a moving hole, the microswitch is disposed on the circuit board adjacent to the moving hole, and the end of the trigger passing through the housing is located in the moving hole.

In some embodiments, the movable contact assembly is adapted to move along the first direction by a first distance so as to switch from an open position to a dead point position, and move along a second direction by a second distance so as to switch from the dead point position to a closed position, the first direction being opposite to the second direction.

In some embodiments, when the movable contact assembly moves along the first direction by a third distance from the open position, the trigger presses the microswitch, and the third distance is greater than a difference between the first distance and the second distance.

In some embodiments, when the movable contact assembly moves along the second direction by a fourth distance from the dead point position, the trigger releases the microswitch, and the fourth distance is less than the second distance.

In some embodiments, the circuit breaker further includes a transmission member disposed in the housing, an end of the movable member away from the movable core contacts the transmission member, and the transmission member contacts the movable contact assembly.

In some embodiments, the circuit breaker further includes a locking member fixedly disposed in the housing and including a moving channel and a limiting groove in communication with the moving channel, the movable member includes a first main part and a first limiting part disposed on an outer surface of the first main part, the first main part is located in the moving channel, and the first limiting part is located in the limiting groove.

In some embodiments, the transmission member includes a second limiting part, and when the transmission member rotates, the second limiting part is adapted to rotate to a position corresponding to the limiting groove, or rotate to a position staggered from the limiting groove.

In some embodiments, the locking member includes a locking bevel, an end of the second limiting part away from the movable contact assembly is provided with a rotating bevel, and the rotating bevel interacts with the locking bevel to drive the transmission member to rotate.

It should be understood that what is described in this section is not intended to limit the critical features or essential features of the embodiments of the present disclosure, nor is it intended to limit the scope of the disclosure. Other features of the present disclosure will become readily appreciated from the following description.

### BRIEF DESCRIPTION OF THE DRAWINGS

The above and other features, advantages, and aspects of various embodiments of the present disclosure will become more apparent with reference to the following detailed description taken in conjunction with the accompanying drawings. In the drawings, the same or similar reference signs denote the same or similar elements, wherein:

FIG. 1 shows a schematic structural diagram of a circuit breaker according to some embodiments of the present disclosure;

FIG. 2 shows a cross-sectional view of a circuit breaker according to some embodiments of the present disclosure, where a movable contact assembly is in an open position;

FIG. 3 shows an exploded view of a movable member, a transmission member, and a locking member according to some embodiments of the present disclosure;

FIG. 4 shows a schematic structural diagram of a movable contact assembly and a trigger according to some embodiments of the present disclosure;

FIG. 5 shows a schematic working diagram of a movable contact assembly according to some embodiments of the present disclosure;

FIG. 6 shows a cross-sectional view of a circuit breaker according to some embodiments of the present disclosure, where a movable contact assembly is in a dead point position during a closing process;

FIG. 7 shows a cross-sectional view of a circuit breaker according to some embodiments of the present disclosure, where a movable contact assembly is in a closed position;

FIG. 8 shows a cross-sectional view of a circuit breaker according to some embodiments of the present disclosure, where a movable contact assembly is in a dead point position during an opening process; and

FIG. 9 shows a schematic structural diagram of a movable member, a transmission member and a locking member shown in FIG. 7.

Description of Reference Numerals:
100 circuit breaker, 101 open position, 102 dead point position, 103 closed position, 104 stop position, 105 action position, 106 contact position;
1 housing, 11 button, 12 mounting part, 13 second elastic member;
2 electromagnetic assembly, 21 electromagnetic coil, 22 movable core;
3 movable member, 31 first main part, 311 first actuating bevel, 32 first limiting part;
4 movable contact assembly, 41 movable contact bracket, 42 movable contact point, 43 first elastic member;
5 switch assembly, 51 microswitch, 52 circuit board, 521 moving hole, 522 mounting hole;
6 trigger, 61 first surface, 62 second surface;
7 transmission member, 71 second main part, 711 second actuating bevel, 72 second limiting part, 721 rotating bevel;
8 locking member, 81 moving channel, 82 limiting groove, 83 locking bevel;
9. stationary contact assembly;
X first direction; Y second direction; and
X1 first distance, X2 second distance, X3 third distance, X4 fourth distance.

### DETAILED DESCRIPTION

Embodiments of the present disclosure will be described in more detail below with reference to the accompanying drawings. Although the embodiments of the present disclosure are shown in the accompanying drawings, it should be understood that the present disclosure may be implemented in various forms and should not be limited to the embodiments set forth herein. Rather, these embodiments are provided so that this disclosure will be thorough and complete, and will fully convey the scope of the disclosure to those skilled in the art.

The term “including” and variations thereof, as used herein, mean open-ended including, that is, “including but not limited to”. Unless specifically stated, the term “or” means “and/or”. The term “based on” means “based at least in part on”. The terms “an example embodiment” and “an embodiment” mean “at least one example embodiment”. The term “another embodiment” means “at least one further embodiment”. The terms “first”, “second”, and the like may refer to different or identical objects.

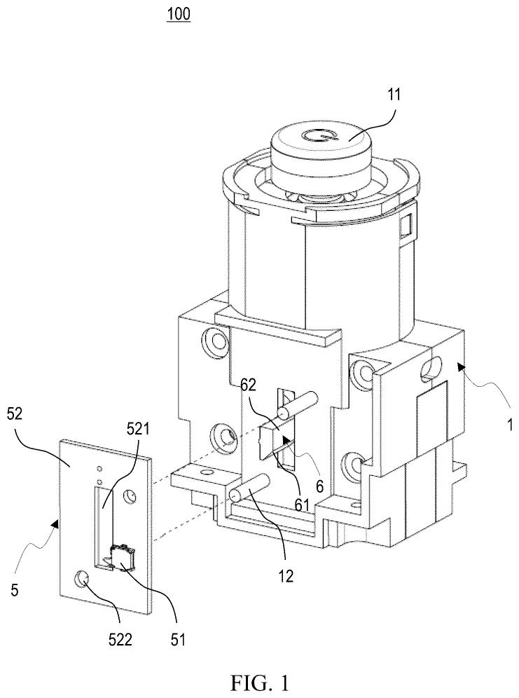

As described above, a mechanical switch needs to be closed prior to an electronic switch being closed during a closing process and the mechanical switch needs to be opened after the electronic switch being opened during an opening process. However, during processes of manually closing and opening the conventional circuit breaker, it is necessary to press a movable contact assembly from a closed position/open position to a dead point position, and then the movable contact assembly rebound to the open position/closed position. During a process of pressing the movable contact assembly to the dead point position, if an operator stops applying a force after the microswitch is pressed, the electronic switch may switch a state, but the movable contact assembly bounces back to the initial position. Therefore, the state of the electronic switch does not match the state of the mechanical switch, resulting in that the circuit breaker cannot realize the function of closing first and opening later. Embodiments of the present disclosure provide a circuit breaker 100 to at least partially solve the above problems. Hereinafter, the principle of the present disclosure will be described with reference to FIGS. 1 to 9.

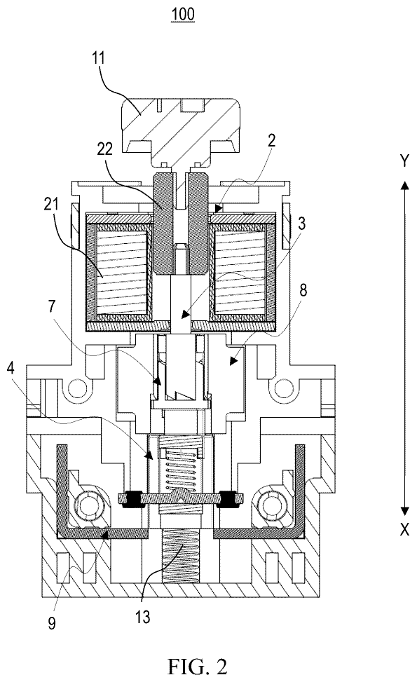

FIG. 1 shows a schematic structural diagram of a circuit breaker 100 according to some embodiments of the present disclosure. FIG. 2 shows a cross-sectional view of a circuit breaker 100 according to some embodiments of the present disclosure, where a movable contact assembly 4 is in an open position 101. As shown in FIGS. 1 to 2, the circuit breaker 100 described herein generally includes a housing 1, an electromagnetic assembly 2, a movable member 3, a movable contact assembly 4, a switch assembly 5, a trigger 6, a transmission member 7, a locking member 8, and a stationary contact assembly 9. The housing 1 serves as a mounting carrier, and the electromagnetic assembly 2, the movable member 3, the movable contact assembly 4, the transmission member 7, the locking member 8, and the stationary contact assembly 9 are each disposed in the housing 1. The switch assembly 5 is disposed on the housing 1, a part of the trigger 6 is disposed in the housing 1, and a further part of the trigger 6 is capable of passing through the housing 1 to interact with the switch assembly 5.

Referring to FIGS. 1 to 2, in some embodiments, the electromagnetic assembly 2 may include an electromagnetic coil 21 and a movable core 22. The movable core 22 is disposed in the electromagnetic coil 21. When the electromagnetic coil 21 is energized, the movable core 22 is capable of moving along a first direction X under driving of an electromagnetic force, thereby realizing electric closing and opening processes of the mechanical switch. In addition, a button 11 is disposed on the housing 1, and the button 11 may be connected to the movable core 22; therefore, in a case that the electromagnetic coil 21 is not energized, the movable core 22 is capable of being driven to move along the first direction X by manually pressing the button 11, thereby realizing manual closing and opening processes of the mechanical switch.

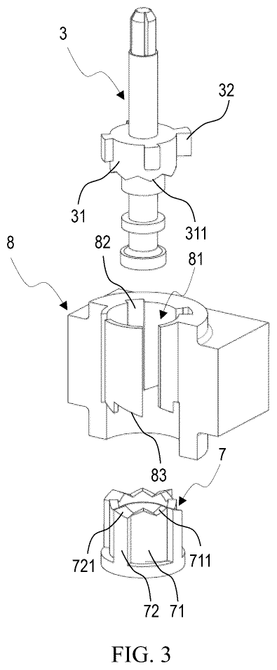

FIG. 3 shows an exploded view of the movable member 3, the transmission member 7, and the locking member 8 according to some embodiments of the present disclosure. In FIG. 3, a portion of a body of the locking member 8 is not shown, so as to prevent it from blocking internal components. As shown in FIG. 2 to FIG. 3, in some embodiments, the movable member 3 is connected to the movable core 22, and then the movable member 3 is capable of moving following the movable core 22. The movable contact assembly 4 interacts with the movable member 3, so that the moving contact assembly 4 is capable of moving under driving of the movable member 3.

Specifically, referring to FIG. 2 to FIG. 3, an end of the movable member 3 away from the movable core 22 contacts the transmission member 7, and the transmission member 7 contacts the movable contact assembly 4. Therefore, during a manual pressing process of the movable core 22 or an electromagnetic driving process of the movable core 22, the movable core 22 is capable of moving along the first direction X, and the movable member 3, the transmission member 7, and the movable contact assembly 4 are also move along the first direction X under driving of the movable core 22, thereby realizing the closing and opening processes of the mechanical switch.

Referring back to FIG. 1, in some embodiments, the switch assembly 5 may include a microswitch 51 and a circuit board 52, and the microswitch 51 is disposed on the circuit board 52. The circuit board 52 is disposed on an outer surface of the housing 1. The circuit board 52 includes a moving hole 521. The microswitch 51 is disposed adjacent to the moving hole 521. An end of the trigger 6 that passes through the housing 1 is located in the moving hole 521. Thus, the trigger 6 is capable of interacting with the microswitch 51.

The switch assembly 5 according to embodiments of the present disclosure can be disposed on the housing 1 in any way, and embodiments of the present disclosure are not limited thereto. For example, with continued reference to FIG. 1, in some embodiments, the circuit board 52 includes a pair of mounting holes 522. Correspondingly, the housing 1 includes a pair of mounting parts 12. Each of the mounting holes 522 may be mated with a corresponding mounting part 12.

It can be understood that the trigger 6 may be disposed on any movable component in the circuit breaker 100. For example, the trigger 6 may be disposed on one of the movable core 22, the movable member 3, and the movable contact assembly 4. Thus, during the movement of the movable core 22 along the first direction X, the trigger 6 is capable of moving under driving of the movable core 22. In addition, during the movement of the movable core 22 along the second direction Y, the trigger 6 is also capable of moving under the driving of the movable core 22. For example, the trigger 6 may alternatively be disposed on the button 11, and then the trigger 6 is capable of moving following the button 11. The embodiments of the present disclosure are not limited thereto.

Further, during a process of manually pressing the movable core 22, the trigger 6 can move along the first direction X in the moving hole 521, so that the trigger 6 is capable of pressing the microswitch 51 or releasing the microswitch 51. In addition, the microswitch 51 may be connected to the circuit board 52, the circuit board 52 may be connected to a control board (not shown in the figure), and the control board may be connected to the electromagnetic coil 21. Thus, in a case that the microswitch 51 is pressed, the control board is capable of receiving a signal output from the microswitch 51, and the control board is capable of remotely controlling energization of the electromagnetic coil 21.

Further, in a case that the microswitch 51 is not pressed, contact points of the microswitch 51 are disconnected, and during a process of the microswitch 51 being pressed, the elastic sheet of the microswitch 51 is pressed by the trigger 6, causing the contact points to contact with each other.

It should be noted that, referring to FIG. 1 to FIG. 2, on the one hand, the trigger 6 moves along the first direction X, and the elastic sheet of the microswitch 51 moves along a direction perpendicular to the first direction X after being pressed by a force. That is to say, a moving direction of the trigger 6 is different from a moving direction of the elastic sheet of the microswitch 51, and therefore a moving distance of the trigger 6 is different from a moving distance of the spring, so that even if the trigger 6 moves a longer distance along the first direction X, it will not cause the moving distance of the elastic sheet to exceed its movement stroke limit, thereby preventing the microswitch 51 from being damaged. On the other hand, the trigger 6 includes a first surface 61 and a second surface 62, the first surface 61 is disposed obliquely, and the second surface 62 is disposed vertically along the first direction X. During a process of the microswitch 51 being pressed by the trigger 6, at first, the elastic sheet is gradually pressed down through the interaction between the first surface 61 and the elastic sheet, and as the trigger 6 continues to move along the first direction X, the second surface 62 interacts with the elastic sheet, and the elastic sheet no longer moves. In this way, damage to the microswitch 51 can be avoided as well.

Further, during electrically closing and opening processes, since the control board can be connected to the electromagnetic coil 21, the electromagnetic coil 21 is capable of being remotely controlled to be energized by the control board.

According to embodiments of the present disclosure, during the movement of the movable core 22 along the first direction X when being pressed, the trigger 6 is capable of pressing the microswitch 51. The electromagnetic coil 21 is energized when the microswitch 51 is pressed, and then the movable core 22 is capable of moving along the first direction X under driving of an electromagnetic force, thereby driving the movable contact assembly 4 to continue to move, and avoiding the problem that the movable core 22 and the movable contact assembly 4 rebound due to an operator stopping applying a force.

In summary, the circuit breaker 100 according to embodiments of the present disclosure adds an auxiliary suction function during manual closing and opening processes to avoid the problem that the mechanical switch fails to switch state due to the rebound of the movable core 22 and the movable contact assembly 4 in a case that the electronic switch has switched state, thereby ensuring that the circuit breaker 100 realizes a function of closing first and opening later.

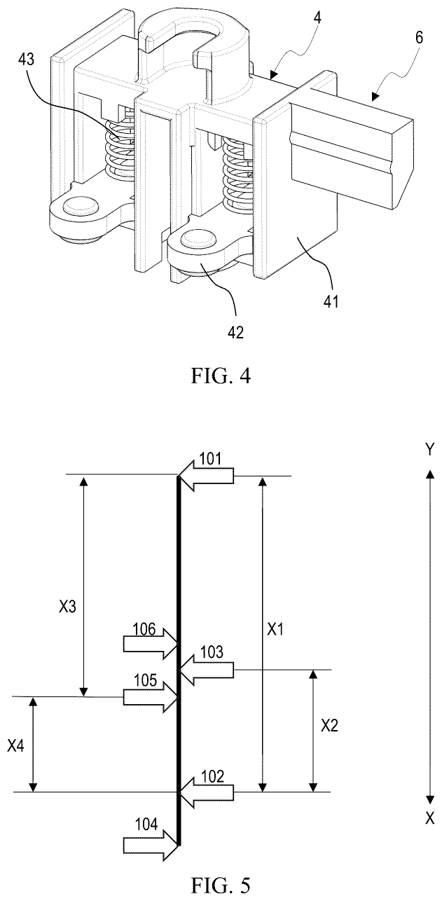

FIG. 4 shows a schematic structural diagram of a movable contact assembly 4 and a trigger 6 according to some embodiments of the present disclosure. As shown in FIG. 4, in some embodiments, the movable contact assembly 4 includes a movable contact bracket 41. The trigger 6 may be disposed on the movable contact bracket 41. Hereinafter, the working principle of the circuit breaker 100 according to embodiments of the present disclosure will be described mainly with reference to the case that the trigger 6 is disposed on the movable contact bracket 41, and it is similar for the case that the trigger 6 is disposed on other components, as long as the relative relationship between an action position 105 and the following positions is ensured, which will not be described herein again.

FIG. 5 shows a schematic working diagram of a moving contact assembly 4 according to some embodiments of the present disclosure. As shown in FIG. 5, specifically, the moving contact assembly 4 may include an open position 101, a dead point position 102, a closed position 103, a stop position 104, an action position 105, and a contact position 106. Understandably, hereinafter, the first direction X is opposite to the second direction Y. A first distance X1 should be greater than a second distance X2. A third distance X3 should be greater than a difference between the first distance X1 and the second distance X2. A fourth distance X4 should be less than the second distance X2. When the movable contact assembly 4 is in the contact position 106, the movable contact point 42 and the stationary contact point (not shown) are just in contact.

Referring to FIG. 5, during the closing process, the movable contact assembly 4 is capable of moving along the first direction X by a first distance X1 so as to switch from the open position 101 to the dead point position 102. During the switching process, at first, the movable contact assembly 4 reaches the contact position 106, then the movable contact assembly 4 reaches the closed position 103 for the first time, then the movable contact assembly 4 reaches the action position 105 for the first time under the condition that the movable contact assembly 4 moves by the third distance X3 from the open position 101, and when it is in the action position 105, the trigger 6 presses the microswitch 51.

With continued reference to FIG. 5, further, after the movable contact assembly 4 reaches the dead point position 102, the movable contact assembly 4 is capable of moving along the second direction Y by the second distance X2 to reset from the dead point position 102 to the closed position 103. During the reset process, under the condition that the movable contact assembly 4 moves by the fourth distance X4 from the dead point position 102, the movable contact assembly 4 is capable of reaching the action position 105 again, and when it is in the action position 105, the trigger 6 releases the microswitch 51.

With continued reference to FIG. 5, during the opening process, instead, the movable contact assembly 4 is capable of moving along the first direction X by the second distance X2 to switch from the closed position 103 to the dead point position 102. During the switching process, the movable contact assembly 4 can pass through the action position 105 for the first time, and when it is in the action position 105, the trigger 6 presses the microswitch 51.

With continued reference to FIG. 5, further, after the movable contact assembly 4 reaches the dead point position 102, the movable contact assembly 4 is capable of moving along the second direction Y by the first distance X1 to switch from the dead point position 102 to the open position 101. During the switching process, at first, under the condition that the movable contact assembly 4 moves by the fourth distance X4 from the dead point position 102, the movable contact assembly 4 is capable of passing through the action position 105 again, and when it is in the action position 105, the trigger 6 releases the microswitch 51. Then, under the condition that the movable contact assembly 4 moves by the second distance X2 from the dead point position 102, the movable contact assembly 4 is capable of reaching the closed position 103 again. Then, the movable contact assembly 4 is capable of reaching contact position 106.

In summary, no matter during the closing process or the opening process of the circuit breaker 100, the time when the movable contact assembly 4 is in the action position 105 for the first time is before the time when the movable contact assembly 4 is in the dead point position 102, and the time when the movable contact assembly 4 is in the action position 105 for the first time is after the time when the movable contact assembly 4 is in the closed position 103 for the first time. It can be understood that, by using a relative relationship between the action position 105 and other positions, it is beneficial to coordinate a state of the mechanical switch and a state of the electronic switch, so as to ensure that the circuit breaker 100 achieves a function of closing first and opening later.

With continued reference to FIG. 5, further, the movable contact assembly 4 is capable of moving by some distance along the first direction X to switch from the dead point position 102 to the stop position 104. The design of the stop position 104 is used to ensure a margin of the structure, so as to ensure that the movable contact assembly 4 is always capable of moving to the dead point position 102.

With continued reference to FIG. 4, further, the movable contact point 42 and the first elastic member 43 are each located inside the movable contact bracket 41. One end of the first elastic member 43 is connected to an inner wall of the movable contact bracket 41, and the other end of the first elastic member 43 is connected to the movable contact point 42. With continued reference to FIG. 2, one end of a second elastic member 13 is connected to the movable contact bracket 41, and the other end of the second elastic member 13 is connected to the housing 1.

It can be understood that, with continued reference to FIG. 4 to FIG. 5, since the time when the movable contact assembly 4 is in the contact position 106 is before the time when the movable contact assembly 4 is in the closed position 103 for the first time, therefore, after the movable contact assembly 4 reaches the contact position 106, the movable contact point 41 contacts the stationary contact point, the movable contact bracket 41 can continue to move along the first direction X, the first elastic member 43 can be compressed, and a force of the first elastic member 43 can cause the movable contact point 42 to press against the stationary contact assembly 9. In addition, with continued reference to FIGS. 2 and 5, during a process of switching the movable contact assembly 4 from the closed position 103 to the dead point position 102, the first elastic member 43 can be continuously compressed, the second elastic member 13 is also continuously compressed, and the second elastic member 13 can store energy. After the moving contact assembly 4 reaches the dead point position 102, the second elastic member 13 releases energy and can drive the moving contact assembly 4 to move along the second direction Y.

Referring back to FIGS. 2 to 3, in some embodiments, the locking member 8 and the movable member 3 are coaxially arranged, so that the movable member 3 is capable of moving along the locking member 8. Specifically, the locking member 8 is fixedly disposed in the housing 1. The locking member 8 may include a moving channel 81 and a limiting groove 82 in communication with the moving channel 81, and the limiting groove 82 is distributed on outside of the moving channel 81. The movable member 3 may include a first main part 31 and a first limiting part 32 disposed on an outer surface of the first main part 31. The first main part 31 may be located in the moving channel 81, and the first limiting part 32 may be located in the limiting groove 82. Thus, the movable member 3 is capable of moving along the locking member 8 and is restricted from rotating.

With continued reference to FIG. 3, in some embodiments, the transmission member 7 may include a second main part 71 and a second limiting part 72. The second limiting part 72 is disposed on an outer surface of the second main body 71. Referring to FIG. 2 to FIG. 3, when the movable contact assembly 4 is in the open position 101, the second limiting part 72 is at a position corresponding to the limiting groove 82. More specifically, the second limiting part 72 is located in the limiting groove 82. Thus, the transmission member 7 is capable of moving along the first direction X with respect to the lock member 8.

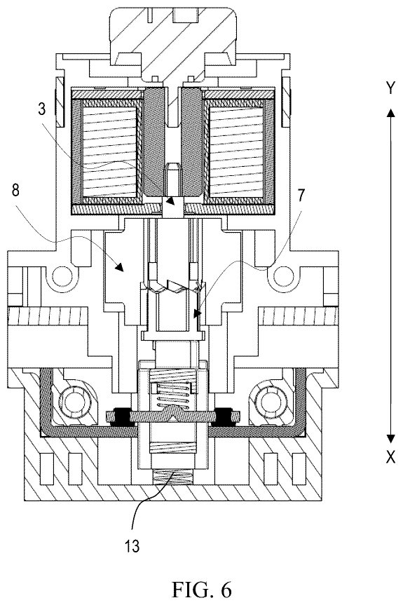

FIG. 6 shows a cross-sectional view of the circuit breaker 100 according to some embodiments of the present disclosure, where a movable contact assembly 4 is in a dead point position 102 during the closing process. As shown in FIGS. 2, 3 and 6, during the process of switching the movable contact assembly 4 from the open position 101 to the dead point position 102, the movable member 3 and the transmission member 7 is capable of moving in the limiting groove 82 and moving along the first direction X.

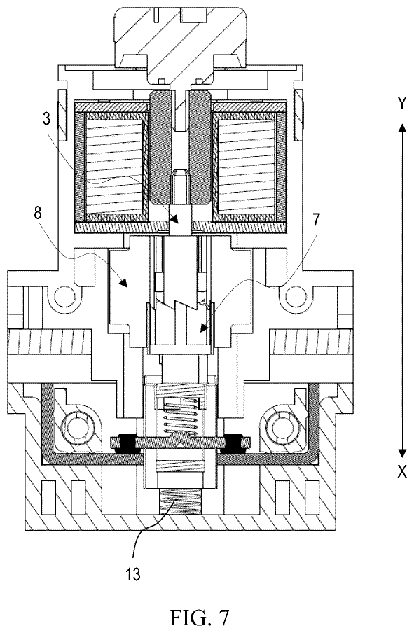

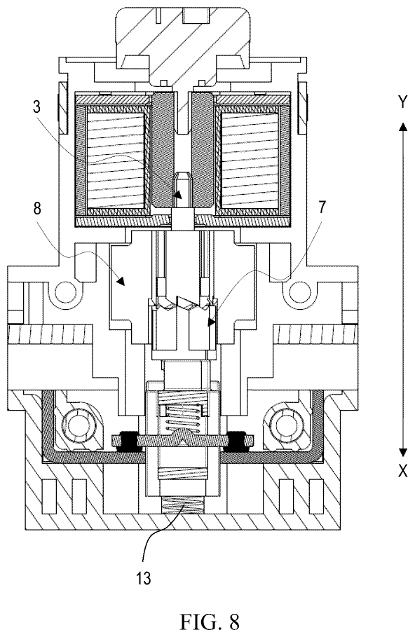

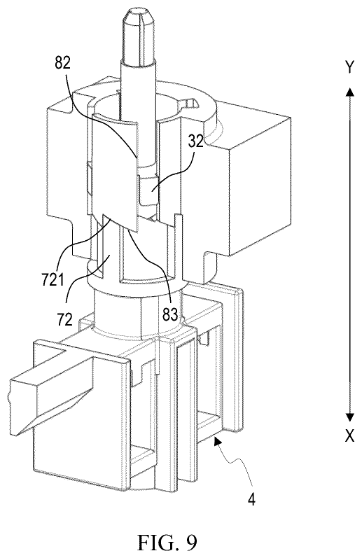

FIG. 7 shows a cross-sectional view of the circuit breaker 100 according to some embodiments of the present disclosure, where the movable contact assembly 4 is in the closed position 103. FIG. 8 shows a cross-sectional view of the circuit breaker 100 according to some embodiments of the present disclosure, where the movable contact assembly 4 is in the dead point position 102 during the opening process. FIG. 9 shows a schematic structural diagram of the movable member 3, the transmission member 7 and the locking member 8 shown in FIG. 7. As shown in FIGS. 3 and 9, the locking member 8 includes a locking bevel 83. An end of the second limiting part 72 away from the movable contact assembly 4 is provided with a rotating bevel 721. The rotating bevel 721 is capable of interacting with the locking bevel 83 to drive the transmission member 7 to rotate. Correspondingly, the first main part 31 may be provided with a first actuating bevel 311. The second main part 71 may be provided with a second actuating bevel 711. The first actuating bevel 311 is capable of interacting with the second actuating bevel 711, and in a case that the first actuating bevel 311 interacts with the second actuating bevel 711, the movable member 3 is capable of providing a driving force to the transmission member 7, so as to drive the transmission member 7 to rotate.

Obviously, as shown in FIGS. 6 to 7 and 9, during the process of switching the movable contact assembly 4 from the dead point position 102 to the closed position 103, at first, since the first actuating bevel 311 is capable of interacting with the second actuating bevel 711, the movable member 3 is capable of providing a driving force to the transmission member 7 to drive the transmission member 7 to rotate clockwise. Then the rotating bevel 721 interacts with the locking bevel 83 and continues to drive the transmission member 7 to rotate clockwise. Finally, the second limiting part 72 is rotated to a position staggered from the limiting groove 82, and the rotating bevel 721 is engaged with and locked to the locking bevel 83. Thus, the transmission member 7 is locked and the movable contact assembly 4 is locked in the closed position 103 without being able to continue to move along the second direction Y.

As shown in FIGS. 3 and 7-9, during the process of switching the movable contact assembly 4 from the closed position 103 to the dead point position 102, the movable member 3 moves along the first direction X and the movable member 3 pushes the transmission member 7 to move along the first direction X. Thus, during the process of switching the movable contact assembly 4 from the dead point position 102 to the open position 101, through the interaction between the first actuating bevel 311 and the second actuating bevel 711, the movable member 3 is capable of providing a driving force to the transmission member 7 to enable the transmission member 7 to rotate clockwise, and enable the rotating bevel 721 of the transmission member 7 to be staggered from the locking bevel 83. Then, the rotating bevel 721 interacts with the locking bevel 83 and continues to drive the transmission member 7 to rotate clockwise. Finally, the second limiting part 72 rotates to a position corresponding to the limiting groove 82. Thus, the transmission member 7 is unlocked and the movable contact assembly 4 can continue to move along the second direction Y until it reaches the open position 101.

It should be noted that the end of the movable member 3 away from the movable core 22 may be located in the movable contact bracket 41. Referring to FIG. 3, in some embodiments, the movable member 3 may pass through the transmission member 7. Certainly, in other embodiments, the movable member 3 may not be disposed in the transmission member 7, and the movable contact bracket 41 may pass through the transmission member 7.

Further, referring to FIGS. 7 and 9, the movable member 3 may pass through the transmission member 7 and be located in the movable contact bracket 41. In a case that the movable contact assembly 4 is in the closed position, since the end of the movable member 3 away from the movable core 22 is located in the movable contact bracket 41, even if the movable contact bracket 41 is limited and cannot move, the movable member 3 can move by a certain distance in a space of the movable contact bracket 41 along the second direction Y until it is limited by the movable contact bracket 41. Thus, in a case that the movable contact assembly 4 is in the closed position, the movable member 3 cannot move to a position corresponding to a position where the movable contact assembly 4 is in the open position, so that the button 11 cannot move to a position corresponding to the position where the movable contact assembly 4 is in the open position, thereby avoiding the problem of incorrect indication. In addition, by moving the movable member 3 by a certain distance along the second direction Y, a space for rotating the transmission member 7 is provided.

It can be understood that, during the closing process of the movable contact assembly 4, although the movable member 3 is in the movable contact bracket 41, the movable member 3 does not contact the movable contact bracket 41. Therefore, the movable member 3 acts on the movable contact bracket 41 through the transmission member 7, so as to drive the movable contact bracket 41 to move.

Referring to FIG. 3 and FIG. 9, in some embodiments, the locking member 8 may include a pair of limiting grooves 82. and an angle between adjacent limiting grooves 82 may be 90 degrees. Correspondingly, the movable member 3 may include a pair of first limiting parts 32, and an angle between adjacent first limiting parts 32 may be 90 degrees. Correspondingly, the transmission member 7 may include a pair of second limiting parts 72, and an angle between adjacent second limiting parts 72 may be 90 degrees.

Of course, the movable member 3, the transmission member 7 and the locking member 8 according to the embodiments of the present disclosure can further include other structures, as long as they can realize the above described function (for example, the locking function) during the closing and opening processes, and the embodiments of the present disclosure are not limited thereto.

Finally, the manual closing and opening processes and automatic closing and opening processes will be described respectively with reference to FIGS. 2 and 5 to 8:

Manual closing: with reference to FIGS. 2 and 5, the button 11 is pressed along the first direction X, and the movable contact assembly 4 moves along the first direction X. The movable contact assembly 4 reaches the contact position 106, the movable contact assembly 4 contacts the stationary contact assembly 9, and the mechanical switch is closed. The movable contact assembly 4 then reaches the closed position 103 for the first time. Continuing to press button 11 along the first direction X, the movable contact assembly 4 passes through the action position 105 for the first time, and the trigger 6 presses the microswitch 51. The microswitch 51 transmits a signal to the control board, and the control board controls the electromagnetic coil 21 to be energized, so as to realize an auxiliary suction function. Referring to FIG. 5 to FIG. 6, the movable contact assembly 4 is switched to the dead point position 102, the second elastic member 13 releases energy and drives the movable contact assembly 4 to move along the second direction Y, the movable contact assembly 4 passes through the action position 105 again, and the trigger 6 releases the microswitch 51. The microswitch 51 transmits a signal to the control board, and the control board controls the electronic switch to be closed. Referring to FIGS. 5 and 7, the movable contact assembly 4 is switched to the closed position 103. Thus, the mechanical switch is closed prior to the electronic switch being closed.

Manual opening: with reference to FIGS. 5 and 7, the button 11 is pressed along the first direction X, and the movable contact assembly 4 moves along the first direction X. The movable contact assembly 4 passes through the action position 105 for the first time, and the trigger 6 presses the microswitch 51. The microswitch 51 transmits a signal to the control board, on the one hand, the control board controls the electronic switch to be opened, and on the other hand, the control board controls the electromagnetic coil 21 to be energized, so as to realize an auxiliary suction function. Referring to FIGS. 5 and 8, the movable contact assembly 4 is switched to the dead point position 102, and the second elastic member 13 releases the energy and drives the movable contact assembly 4 to move along the second direction Y. The movable contact assembly 4 passes through the action position 105 again, and the trigger 6 releases the microswitch 51. Then, the movable contact assembly 4 passes through the closed position 103 and the contact position 106 successively, and the mechanical switch is opened. With reference to FIGS. 2 and 5, the movable contact assembly 4 is switched to the open position 101. Thus the mechanical switch is opened after the electronic switch being opened.

Automatic closing: with reference to FIGS. 2 to 5, the electromagnetic coil 21 is remotely controlled to be energized, the movable core 22 moves along the first direction X, and the movable contact assembly 4 moves along the first direction X. The movable contact assembly 4 reaches the contact position 106, the movable contact assembly 4 contacts the stationary contact assembly 9, and the mechanical switch is closed. Then the movable contact assembly 4 reaches the closed position 103 for the first time. Then the movable contact assembly 4 passes through the action position 105 for the first time, and the trigger 6 presses the microswitch 51. Referring to FIG. 5 to FIG. 6, the movable contact assembly 4 is switched to the dead point position 102, the second elastic member 13 releases energy and drives the movable contact assembly 4 to move along the second direction Y, the movable contact assembly 4 passes through the action position 105 again, and the trigger 6 releases the microswitch 51. The microswitch 51 transmits a signal to the control board, and the control board controls the electronic switch to be closed. Referring to FIGS. 5 and 7, the movable contact assembly 4 is switched to the closed position 103. Thus, the mechanical switch is closed prior to the electronic switch being closed.

Automatic opening: with reference to FIGS. 5 and 7, the electromagnetic coil 21 is remotely controlled to be energized, the movable core 22 moves along the first direction X, and the movable contact assembly 4 moves along the first direction X. The movable contact assembly 4 passes through the action position 105 for the first time, and the trigger 6 presses the microswitch 51. The microswitch 51 transmits a signal to the control board, and the control board controls the electronic switch to be opened. Referring to FIGS. 5 and 9, the movable contact assembly 4 is switched to the dead point position 102, and the second elastic member 13 releases energy and drives the movable contact assembly 4 to move along the second direction Y. The movable contact assembly 4 passes through the action position 105 again, and the trigger 6 releases the microswitch 51. Then, the movable contact assembly 4 passes through the closed position 103 and the contact position 106 successively, and the mechanical switch is opened. With reference to FIGS. 2 and 5, the movable contact assembly 4 is switched to the open position 101. Thus the mechanical switch is opened after the electronic switch being opened.

In summary, the circuit breaker 100 according to embodiments of the present disclosure can realize a function of closing first and opening later, regardless of whether it is manual closing and opening processes or automatic closing and opening processes. In addition, a microswitch 51 is provided, and a state of the movable contact assembly 4 is also able to be detected by means of an action relationship between the microswitch 51 and the trigger 6.

According to an embodiment of the present disclosure, during the movement of the movable core along the first direction when being pressed, the trigger is capable of pressing the microswitch. The electromagnetic coil is energized when the microswitch is pressed, and then the movable core is capable of moving along the first direction under driving of an electromagnetic force, thereby driving the movable contact assembly to continue to move, and avoiding the problem that the movable core and the movable contact assembly rebound due to an operator stopping applying a force. Therefore, the circuit breaker of the embodiment of the present disclosure adds an auxiliary suction function during manual closing and opening processes to avoid the problem that the mechanical switch fails to switch state due to the rebound of the movable core and the movable contact assembly in a case that the electronic switch has switched state, thereby ensuring that the circuit breaker realizes the function of closing first and opening later.

The design of closing first and opening later according to embodiments of the present disclosure may be applied to various circuit breakers to at least partially solve the above-described problems. It should be understood that the design of closing first and opening later according to embodiments of the present disclosure may also be applied to other electrical components, and embodiments of the present disclosure are not limited thereto.

Embodiments of the present disclosure have been described above, and the above description is illustrative, not exhaustive, and is not limited to the disclosed embodiments. Many modifications and variations will be apparent to those of ordinary skill in the art without departing from the scope and spirit of the illustrated embodiments. The selection of terms as used herein is intended to best explain the principles of the embodiments, the practical application or technical improvements to the market, or to enable others of ordinary skill in the art to understand the embodiments disclosed herein.

1. A circuit breaker, comprising:
a housing;
an electromagnetic assembly disposed in the housing and comprising an electromagnetic coil and a movable core disposed in the electromagnetic coil, wherein the movable core is adapted to move along a first direction when the electromagnetic coil is energized;
a movable member disposed in the housing and connected to the movable core;
a movable contact assembly disposed in the housing, wherein the movable contact assembly interacts with the movable member and is adapted to move under driving of the movable member;
a switch assembly disposed on the housing and comprising a microswitch; and
a trigger disposed on one of the movable core, the movable member, or the movable contact assembly,
wherein during movement of the movable core along the first direction when being pressed, the trigger moves under driving of the movable core and is adapted to press the microswitch, and the electromagnetic coil is energized when the microswitch is pressed.

2. The circuit breaker according to claim 1, wherein the movable contact assembly comprises a movable contact bracket, the trigger is disposed on the movable contact bracket, and an end of the trigger passes through the housing.

3. The circuit breaker according to claim 2, wherein the switch assembly further comprises a circuit board disposed on an outer surface of the housing, the circuit board comprises a moving hole, the microswitch is disposed on the circuit board adjacent to the moving hole, and the end of the trigger passing through the housing is located in the moving hole.

4. The circuit breaker according to claim 1, wherein the movable contact assembly is adapted to move along the first direction by a first distance so as to switch from an open position to a dead point position, and move along a second direction by a second distance so as to switch from the dead point position to a closed position, the first direction being opposite to the second direction.

5. The circuit breaker according to claim 4, wherein when the movable contact assembly moves along the first direction by a third distance from the open position, the trigger presses the microswitch, and the third distance is greater than a difference between the first distance and the second distance.

6. The circuit breaker according to claim 4, wherein when the movable contact assembly moves along the second direction by a fourth distance from the dead point position, the trigger releases the microswitch, and the fourth distance is less than the second distance.

7. The circuit breaker according to claim 1, wherein the circuit breaker further comprises a transmission member disposed in the housing, an end of the movable member away from the movable core contacts the transmission member, and the transmission member contacts the movable contact assembly.

8. The circuit breaker according to claim 7, wherein the circuit breaker further comprises a locking member fixedly disposed in the housing and comprising a moving channel and a limiting groove in communication with the moving channel, the movable member comprises a first main part and a first limiting part disposed on an outer surface of the first main part, the first main part is located in the moving channel, and the first limiting part is located in the limiting groove.

9. The circuit breaker according to claim 8, wherein the transmission member comprises a second limiting part, and when the transmission member rotates, the second limiting part is adapted to rotate to a position corresponding to the limiting groove, or rotate to a position staggered from the limiting groove.

10. The circuit breaker according to claim 9, wherein the locking member comprises a locking bevel, an end of the second limiting part away from the movable contact assembly is provided with a rotating bevel, and the rotating bevel interacts with the locking bevel to drive the transmission member to rotate.

11. A method of operating a circuit breaker, comprising:
driving a movable contact assembly by movement of a movable member, wherein the movable member is connected to a movable core of an electromagnetic assembly disposed in a housing, and wherein the movable core is adapted to move along a first direction when an electromagnetic coil of the electromagnetic assembly is energized;
driving a trigger by movement of the movable core, wherein the trigger is disposed on one of the movable core, the movable member, or the movable contact assembly, and wherein the trigger is adapted to press a microswitch of a switch assembly disposed on the housing;
pressing the microswitch with the trigger during the movement of the movable core along the first direction; and
energizing an electromagnetic coil of the electromagnetic assembly when the microswitch is pressed.

12. The method of claim 11, further comprising:
moving the movable contact assembly along the first direction by a first distance to switch from an open position to a dead point position; and
moving the movable contact assembly along a second direction opposite to the first direction by a second distance to switch from the dead point position to a closed position.

13. The method of claim 12, wherein pressing the microswitch with the trigger occurs when the movable contact assembly moves along the first direction by a third distance from the open position, the third distance being greater than a difference between the first distance and the second distance.

14. The method of claim 13, further comprising releasing the microswitch with the trigger when the movable contact assembly moves along the second direction by a fourth distance from the dead point position, the fourth distance being less than the second distance.

15. The method of claim 11, further comprising:
contacting a transmission member disposed within the housing by an end of the movable member away from the movable core; and
contacting the movable contact assembly by the transmission member.

16. The method of claim 15, wherein a locking member is fixedly disposed in the housing and comprises a moving channel and a limiting groove in communication with the moving channel, and further comprising:
rotating a limiting part of the transmission member to a position corresponding to the limiting groove to move the movable contact assembly in an open position.

17. The method of claim 15, wherein a locking member is fixedly disposed in the housing and comprises a moving channel and a limiting groove in communication with the moving channel, and further comprising:
rotating a limiting part of the transmission member to a position staggered from the limiting groove to lock the movable contact assembly in a closed position.
